(19) United States
(12) Patent Application Publication
(10) Pub. No.: US 2025/0261696 A1
(43) Pub. Date: Aug. 21, 2025

(54) CONTROL CIRCUITRY FOR AN AEROSOL-GENERATING DEVICE

(71) Applicant: Philip Morris Products S.A., Neuchatel (CH)

(72) Inventors: Gregory André CRISTIAN, Saint-Sulpice (CH); Andrew James MCLAUCHLAN, Poliez-Le-Grand (CH)

(73) Assignee: Philip Morris Products S.A., Neuchatel (CH)

(21) Appl. No.: 19/099,952

(22) PCT Filed: Aug. 17, 2023
(86) PCT No.: PCT/EP2023/072708

§ 371 Date: Jan. 30, 2025

(30) Foreign Application Priority Data
Aug. 25, 2022 (EP) 22192080.4

(51) Int. Cl. A24F 40/49; A24F 40/53; A24F 40/60; A24F 40/65; G06F 21/31; H04L 9/40

(52) U.S. Cl. CPC A24F 40/49; A24F 40/53; A24F 40/60; A24F 40/65; G06F 21/31; H04L 63/08

(57) ABSTRACT

An aerosol-generating system is provided, including: control circuitry; an aerosol-generating device and/or a companion device for the aerosol-generating device including a communications interface to provide device connectivity; and user interface components including: user interface components of the aerosol-generating device, of the companion device, or any combination of input and output elements of the aerosol-generating and/or companion devices, the aerosol-generating device having a locked state in which it is prohibited from delivering aerosol and an unlocked state in which it is permitted to deliver aerosol, and the circuitry being configured to perform an authentication process for authenticating the user.

The invention relates to control circuitry for an aerosol-generating device, to the aerosol-generating device comprising the control circuitry, to an aerosol-generating system comprising the aerosol-generating device, and to a method for authenticating the aerosol-generating device for use.

The aerosol-generating system may further comprise a companion device for storing the aerosol-generating device. The aerosol-generating device may be designed as a handheld device that can be used by a user for consuming, for instance in one or more usage sessions, aerosol generated by an aerosol-generating article. The aerosol-generating article may comprise an aerosol-forming substrate, such as a tobacco containing substrate, often in the form of a stick. The stick can be configured in shape and size to be inserted at least partially into the aerosol-generating device, which may comprise a heating element for heating the aerosol-forming substrate. Other exemplary aerosol-generating articles may comprise a cartridge containing a liquid that can be vaporized during aerosol consumption by the user. Such cartridges can also be configured in shape and size to be inserted at least partially into the aerosol-generating device. Alternatively, the cartridge may be fixedly mounted to the aerosol-generating device and refilled by inserting liquid into the cartridge. The aerosol-generating article may comprise an aerosol-generating substrate comprising nicotine and/or (an) other active ingredient(s).

It is desirable to perform youth access prevention (YAP) methods to prevent underage users from accessing and using such aerosol-generating devices. Some online YAP methods require the user to register the device and activate it for use by connecting it to a computing device such as a smartphone, personal computer or the like on which a registration application is running. The application may be provided as a USB application. The connection to the computing device may be achieved via Bluetooth Low Energy (BLE). However, the connectivity and the applications required in order for the online YAP method to be performed in the above-described manner may be technically problematic. Offline YAP methods have therefore been proposed to unlock a device without the need for such connectivity or applications. Some offline YAP methods are, however, vulnerable to brute force attacks.

It would be desirable to provide YAP methods which at least partially overcome the above-mentioned technical problems. This is achieved by the subject-matter of the independent claims. Optional features are provided by the dependent claims and by the following description.

According to a first aspect, there is provided control circuitry for an aerosol-generating device or for an aerosol-generating system comprising the aerosol-generating device. The aerosol-generating device has a locked state in which the aerosol-generating device is prohibited from delivering aerosol and an unlocked state in which the aerosol-generating device is permitted to deliver aerosol. The control circuitry is configured to perform an authentication process for authenticating the user. The control circuitry may be configured, during an offline phase of the authentication process, to permit the user to make a first predetermined number of attempts to input valid authentication information using one or more user interface components. The control circuitry may be further configured, in response to receiving valid authentication information from the user before the first predetermined number of attempts has been exceeded, to determine to transition the aerosol-generating device from the locked state to the unlocked state. The control circuitry may be further configured, in response to determining that the first predetermined number of attempts has been exceeded before the user has input valid authentication information, to proceed to an online phase of the authentication process.

Beginning with the offline phase enables the authentication process such as a YAP method to be completed without relying on any device connectivity and without the use of any external application. Moreover, the solution described herein prevents the use of brute force attacks to gain access to the locked features of the aerosol-generating device by transitioning to the online phase after an excessive number of forceful attempts to unlock the aerosol-generating device during the offline phase. Unlocking of the aerosol-generating device by an unauthorized user can thereby be effectively and reliably be prohibited, such that use of the aerosol-generating device for aerosol consumption by unauthorized users can be effectively and reliably prevented.

The control circuitry may be further configured to: respond to an unsuccessful attempt by the user to input valid authentication information during the offline phase by determining whether a second predetermined number of attempts has been exceeded, wherein the second predetermined number of attempts is lower than the first predetermined number of attempts; and, if the second predetermined number of attempts has been exceeded, to delay the offline phase until a first time delay period has expired. The control circuitry may be configured to continue the offline phase without delay if the second predetermined number of attempts has not been exceeded.

The control circuitry may be further configured to: respond to an unsuccessful attempt by the user to input valid authentication information during the offline phase by determining whether a third predetermined number of attempts has been exceeded, wherein the third predetermined number of attempts is lower than the first predetermined number of attempts and higher than the second predetermined number of attempts; and, if the third predetermined number of attempts has been exceeded, to delay the offline phase until a second time delay period has expired. The control circuitry may be configured to continue the offline phase without delay if the third predetermined number of attempts has not been exceeded. The second time delay period may be longer than the first time delay period.

The first, second, and/or third predetermined number of attempts may be defined in terms of consecutive and/or non-consecutive attempts.

The control circuitry may be configured to delay the offline phase by prohibiting the user from inputting further authentication information using the one or more user interface components or by refraining from authenticating the user based on further authentication information input by the user.

The control circuitry may be further configured to receive, during each attempt of the offline phase, user-input authentication information from the one or more user interface components and to authenticate the user by determining the validity of the user-input authentication information.

The control circuitry may be further configured to control the user interface components to guide the user in inputting the authentication information as part of a guided interactive input process, for example by controlling the user interface components to output user-perceptible guidance signals in response to control signals from the control circuitry for guiding the user during the guided interactive input process, such as to (i) prompt the user to take predetermined action, to (ii) provide the user with feedback relating to progress of the guided interactive input process, or both (i) and (ii). The interactive input process is thus one example of a guided human-machine interaction process. The user-perceptible guidance signals may comprise any one or more of visual signals, audible signals, and haptic signals. To this end, the user interface components may comprise one or more output elements, including for example any combination of one or more of the following elements: a visual indicator (such as a light source, for example an LED, incandescent tube, compact fluorescent lamp), a haptic output element (such as an eccentric rotating mass motor, linear resonant actuator, vibrotactile actuator such as a C2 tactor, a piezoelectric actuator), an audible output element such as a speaker or the like. The user interface components further comprise one or more input elements such as a button (e.g. a pushbutton), touchscreen, microphone. In one implementation, the user interface components comprise a plurality of LEDs and a pushbutton. In any of these ways, the user interface components facilitate implementation of the offline phase of the authentication process while conserving device real estate in what may be a small-form-factor aerosol-generating device or companion device.

The control circuitry may be configured to receive the user-input authentication information during multiple time windows of predetermined duration, each time window corresponding to a respective digit of a sequence of digits forming the authentication information, and to attribute user input received via the one or more user interface components during a said time window to the digit corresponding to the said time window. The control circuitry may be configured to trigger a timeout in response to no user input being received by the one or more user interface components within a predetermined time period starting from the beginning of a respective one of the time windows. The control circuitry may be configured to initiate a first one of the time windows in response to a user interacting with the one or more user interface components. The control circuitry may be configured to initiate the first one of the time windows in response to receiving a predetermined signal generated by the user interacting with the one or more user interface components. The one or more user interface components may comprise a pushbutton, and the predetermined signal may be generated by the user pressing the pushbutton a predetermined number of times. For instance, the first time window may be initiated by the user pressing the pushbutton a predetermined number of times (e.g. 5) within a predetermined amount of time (e.g. 30 seconds).

Before and/or during one or more of the time windows (for instance, before and/or during the first time window), there may be a preliminary time window. The control circuitry may be configured to determine that the attempt by the user to input valid authentication information was unsuccessful if no user-input authentication is received during the preliminary time window, and to store the received user-input authentication (to be attributed to the corresponding digit) and to initiate the corresponding time window and/or to continue running the corresponding time window (to allow the corresponding digit to be completed) if user-input authentication is received during the preliminary time window.

The control circuitry may be configured to control the user interface components to output user-perceptible guidance signals indicating at least the beginnings of respective time windows. The control circuitry may be configured to control the user interface components to output user-perceptible guidance signals indicating that the said time window is running. The control circuitry may be configured to control the user interface components to output user-perceptible guidance signals indicating for which digit of the sequence the user is being guided to provide input. The aerosol-generating device may be provided with a number of output elements corresponding to the number of digits in the sequence. The control circuitry may be configured to use the position of an active output element with respect to inactive output elements to indicate the position of the digit within the sequence for which input is expected.

The control circuitry may be configured to interpret multiple signals arising from repeated user operation of a same said user interface component during a said time window as a coded input signal defining the digit of the sequence to which the said time window corresponds. The said user interface component may be a power button of the aerosol-generating device.

The sequence of digits forming the authentication information may comprise a personal identification number or code, e.g. a pin code. Thus, a separate time window is provided for entry of each digit of the sequence or pin code, thereby providing certainty and security concerning which digit is currently being entered. By “attribute” is meant that the control circuitry associates the user input received during the said time window to the digit corresponding to the said time window, or that the control circuitry uses that user input received during the said time window to determine or calculate the value of the digit corresponding to the said time window. To enhance security, the control circuitry may be configured to trigger a timeout in response to no user input being received by the one or more user interface components within a predetermined time period starting from the beginning of a respective one of the time windows. Consequently, the control circuitry may be further configured to determine not to transition the aerosol-generating device to the unlocked state in response to the triggering of the timeout. By “timeout” is meant that a timer begins running at the start of the predetermined period and at the end of the predetermined period an interrupt or trigger signal is generated, thereby “triggering” the timeout, if predetermined action was not taken to cancel or reset the timer during the predetermined period.

During the offline phase, the control circuitry may be configured to respond to an unsuccessful attempt by the user to input valid authentication information by determining not to transition the aerosol-generating device from the locked state to the unlocked state. The control circuitry may be further configured to compare the user-input authentication information with prestored reference authentication information and to determine, based on an outcome of the comparison, whether to transition the aerosol-generating device from the locked state to the unlocked state. The reference authentication information may be stored in a data storage and/or memory of the aerosol-generating device and/or the companion device. For example, the reference authentication information may be acquired during and stored upon completion of an age verification process, as discussed herein. The control circuitry may be configured to determine the validity of user-input authentication information using a key derivation mechanism.

The control circuitry may be configured, during the online phase of the authentication process, to: transmit an unlock request to a server to transition the aerosol-generating device from the locked state to the unlocked state, wherein the unlock request comprises unique device-identification information identifying the aerosol-generating device and time-limited nonce information corresponding to an unlockable feature of the aerosol-generating device; receive an unlock grant from the server in response to the transmitted unlock request; and transition the aerosol-generating device from the locked state to the unlocked state in response to reception of the unlock grant. The unlock grant may be at least partially encrypted. The unlock grant may be decryptable using a public key stored on the aerosol-generating device. The control circuitry may be configured to transition the aerosol-generating device from the locked state to the unlocked state in response to reception of the unlock grant by: decrypting the unlock grant; determining whether the decrypted unlock grant comprises the unique device identification information and the time-limited nonce information; and unlocking the unlockable feature in response to determination that the decrypted unlock grant comprises the unique device-identification information and the time-limited nonce information. The control circuitry may be configured to terminate unlocking the unlockable feature if the unlock grant is not received following a validity time period after the unlock request is transmitted to the server. The control circuitry may be configured to restrict a number of unlock grants transmitted to the aerosol-generating device. The unique device-identification may comprise a serial number. Additionally or alternatively, the online phase may be performed using an external computing device or telephone, whereby the user contacts an authentication agency. In this way, a comprehensive and secure procedure to determine the user's age can be implemented, for example based on personal data or information of the user, such as an identity card, a passport, a credit card, a driving license, a social security number of the user, or the like. Hence, the real age of the user can be reliably and unambiguously determined.

The authentication process may comprise a youth access prevention process. Performing the authentication process may comprise identifying the user, i.e. determining and/or verifying the identity of the user, and/or determining whether or not the user is authorized to transition the aerosol-generating device into the unlocked state to permit delivery and/or generation of aerosol. Accordingly, a “successful authentication” of the user, e.g., one following a successful attempt by the user to input valid authentication information during the offline phase, or following reception of the unlock grant during the online phase, may comprise verifying the identity of the user, or, more particularly, determining that the user is authorized for transitioning the aerosol-generating device into the unlocked state. An “unsuccessful authentication” of the user may comprise failing to verify the identity of the user, or, more particularly, determining that the user is not authorized for transitioning the aerosol-generating device into the unlocked state. For example, the authentication process may comprise an age verification process for determining whether the user of the aerosol-generating device has reached the minimum age as indicated by an age threshold. The age threshold may comprise a predefined minimum age of a user of the aerosol-generating device. In certain jurisdictions, for example, aerosol consumption may be permitted for citizens or individuals having reached a certain minimum age and/or having an age equal to or above the minimum age. Further, at least in some jurisdictions, an individual having reached this minimum age may be regarded as being of full age and/or as being an adult. Accordingly, the age threshold may be indicative, representative, and/or descriptive of the minimum age which a user should have for using the aerosol-generating device for aerosol consumption. Additionally or alternatively, the age threshold may be indicative, representative, and/or descriptive of a majority age, above which the user may be regarded as an adult. For example, the age threshold may range from 14 years to 25 years, such as 16 years, 18 years or 21 years. The age verification process may thus be usable for determining whether the user of the aerosol-generating system is of full age, has reached majority age and/or is an adult. The age verification process may be associated with a registration procedure or a set-up procedure prior to or at a first use of the aerosol-generating device by the user. By determining that the user has reached the age threshold based on the age verification process, misuse or legally abusive use of the aerosol-generating device for aerosol consumption by a user not having reached the age threshold and/or having an age below the age threshold can be reliably and effectively prohibited. In particular, use of the aerosol-generating device for aerosol consumption by an underage user can be reliably and effectively prohibited.

The control circuitry may be further configured to transition the aerosol-generating device to the unlocked state in response to a successful authentication of the user. The control circuitry may be further configured to transition the aerosol-generating device to the unlocked state by one or more of (i) modifying a value of an authentication indicator stored in data storage, (ii) adding an authentication indicator to data storage, (iii) removing an authentication indicator from data storage. Additionally or alternatively, the control circuitry may be further configured to transition the aerosol-generating device to the unlocked state by enabling one or more functions of the aerosol-generating device that was previously disabled when the aerosol-generating device was in the locked state. Additionally or alternatively, the control circuitry may be further configured to transition the aerosol-generating device to the unlocked state by transmitting an unlock signal to a companion device for the aerosol-generating device, the companion device being configured to enable, in response to receipt of the unlock signal, one or more functions of one or more of the aerosol-generating device and the companion device that was previously disabled when the aerosol-generating device was in the locked state. The one or more functions enabled in the unlocked state may be essential for the delivery of aerosol by the aerosol-generating device, the enabling comprising enabling one or more of: (i) electrical energy supply components (e.g. to charge the aerosol-generating device), (ii) vaporizable-liquid supply components, (iii) heating components, (iv) airflow-enabling components, (v) actuation elements for user actuation of one or more of the other said components. For example, insertion of an aerosol-generating article into the aerosol-generating device may be prohibited in the locked state, and insertion of the aerosol-generating article may be permitted in the unlocked state. Such functionality which can be enabled or disabled may also be described herein in terms of lockable and unlockable features. Additionally or alternatively, the control circuitry may be further configured to transition the aerosol-generating device to the unlocked state by disabling one or more mechanical lock components and/or flow path blocking components, which are configured when in an enabled state to prevent the delivery and/or generation of aerosol. However, any other means for permitting aerosol-generation in the unlocked state and prohibiting aerosol-generation in the locked state may be implemented. The control circuitry may be further configured to determine not to transition the aerosol-generating device from the locked state to the unlocked state based on an unsuccessful authentication of the user. The control circuitry may be further configured to maintain the aerosol-generating device in the locked state in response to determining not to transition the aerosol-generating device from the locked state to the unlocked state.

The control circuitry may further control one or more functions or functionalities of the aerosol-generating device. The control circuitry may comprise one or more processors for data processing. Additionally or alternatively, the aerosol-generating device may comprise a data storage and/or memory for storing data, such as for example software instructions, a computer program, and/or other data.

According to a second aspect, there is provided an aerosol-generating device comprising the control circuitry of the first aspect.

The aerosol-generating device may be configured or designed as a hand-held device usable by the authorized user to consume an aerosol-generating article, for example during one or more usage sessions (also referred to as “experiences” or “experience sessions”). For instance, an aerosol-generating article usable with the aerosol-generating device can comprise an aerosol-forming substrate, such as a tobacco containing substrate, which may be assembled, optionally with other elements or components, in the form of a stick at least partially insertable into the aerosol-generating device. Additionally or alternatively, an aerosol-generating article usable with the aerosol-generating device can comprise at least one cartridge containing a liquid that can be vaporized during aerosol consumption by the user. Such cartridge can be a refillable cartridge fixedly mounted at the aerosol-generating device or the cartridge can be at least partially inserted into the aerosol-generating device.

According to a third aspect, there is provided a companion device for the aerosol-generating device, the companion device comprising the control circuitry of the first aspect.

The companion device, also describable as a receiving device, may generally refer to a supporting device for supporting and/or storing the aerosol-generating device. The companion device may be a portable companion device. In the context of the present disclosure, the companion device may be configured for at least partially receiving the aerosol-generating device. For example, the companion device may be configured for being physically coupled to the aerosol-generating device. Such physical coupling can, for example, comprise a mechanical coupling based on an attachment means, such as a hook mechanism, a latch mechanism, a snap-fit mechanism or the like, based on which the aerosol-generating device can be mechanically coupled to the companion device and/or a housing thereof. Additionally or alternatively, the aerosol-generating device can be physically coupled to the companion device based on a magnetic or electromagnetic coupling. Additionally or alternatively, the aerosol-generating device can be at least partially inserted into the companion device, for example, into an opening of the companion device. Further, the aerosol-generating device and the companion device may refer to physically separate components or elements of an aerosol-generating system.

For communicating with each other and/or with the external computing device and/or for exchanging data or signals, the aerosol-generating device and/or the companion device may comprise at least one communications interface. The communications interfaces can be configured for wireless communication, for wired communication, or both. For instance, the communications interfaces can be configured for communicative coupling via an Internet connection, a wireless LAN connection, a WiFi connection, a Bluetooth connection including BLE, a mobile phone network, a 3G/4G/5G connection and so on, an edge connection, an LTE connection, a BUS connection, a wireless connection, a wired connection, a radio connection, a near field connection, an IoT connection or any other connection using any appropriate communication protocol.

The aerosol-generating device and/or the companion device may include at least one energy storage for storing electrical energy and/or for supplying the aerosol-generating device with electrical energy. For example, the companion device may be configured to supply electrical energy to the aerosol-generating device to charge the at least one energy storage of the aerosol-generating device. In other words, the companion device may be configured to charge the aerosol-generating device and/or the at least one energy-storage thereof. The at least one energy storage of the aerosol-generating device may, for example, comprise at least one battery, at least one accumulator, at least one capacitor or any other energy storage. The companion device may be configured to supply the energy storage of the aerosol-generating device with electrical energy, when the aerosol-generating device is at least partially received by the companion device. The companion device may comprise one or more batteries for supplying electrical energy to the energy storage of the aerosol-generating device. The companion device may be configured to supply the energy storage of the aerosol-generating device with electrical energy wirelessly, for example based on induction. Additionally or alternatively, the companion device may be configured to supply the energy storage of the aerosol-generating device with electrical energy via one or more electrical connectors between the companion device and the aerosol-generating device. For instance, the aerosol-generating device and the companion device may each include at least one electrical connector for electrically coupling the companion device with the aerosol-generating device, when the aerosol-generating device is at least partially received by the companion device. By way of example, the companion device may comprise an opening for at least partially receiving the aerosol-generating device. By at least partially inserting the aerosol-generating device into the opening, one or more electrical connections may be established between one or more electrical connectors of the aerosol-generating device and the companion device. Additionally or alternatively, the aerosol-generating device may be physically and/or mechanically coupled to the companion device, for example to a housing of the companion device, such that the aerosol-generating device is at least partially received by the companion device and such that one or more electrical connections can be established between the aerosol-generating device and the companion device. Optionally, establishing an electrical connection between the companion device and the aerosol-generating device, for example via the one or more electrical connectors of the aerosol-generating device and the companion device, may establish a communicative coupling and/or a communication connection between the companion device and the aerosol-generating device, for example for transmission of the authentication signal. By way of example, the at least one electrical connector of the companion device may be combined and/or may comprise the communications interface of the companion device. In other words, the at least one electrical connector of the companion device can be configured as communications interface for communicatively coupling the companion device with the aerosol-generating device. Additionally or alternatively, the at least electrical connector of the aerosol-generating device may be combined and/or may comprise the communications interface of the aerosol-generating device. In other words, the at least one electrical connector of the aerosol-generating device can be configured as communications interface for communicatively coupling the aerosol-generating device with the companion device. Accordingly, the authentication signal may be transmitted from the companion device to the aerosol-generating device via the one or more electrical connectors of the companion device and the aerosol-generating device. It should be noted, however, that the communications interface of one or both of the companion device and the aerosol-generating device can be physically separate and independent from the at least one electrical connector of the companion device and/or the aerosol-generating device. A charge cycle may refer to a period of time, in which the aerosol-generating device is continuously supplied with electrical energy by the companion device. During a charge cycle, the at least one energy storage may be partly or entirely charged.

According to a fourth aspect, there is provided an aerosol-generating system comprising the control circuitry of the first aspect, optionally also the aerosol-generating device, and optionally also the companion device. The control circuitry may be fully contained within only one of the said components of the system or may be distributed between multiple components. The control circuity may for example be distributed between the aerosol-generating device and the companion device.

According to a fifth aspect, there is provided a server configured to perform at least the online phase of the authentication process in conjunction with the aerosol-generating device. More particularly, there is provided a server for unlocking an unlockable feature of an aerosol-generating device, the server comprising: a communications interface to transfer data to and from an aerosol-generating device; and control circuitry operably coupled to the communications interface, wherein the control circuitry is configured to: receive an unlock request from the aerosol-generating device to unlock the unlockable feature, wherein the unlock request comprises unique device identification information identifying the aerosol-generating device and time-limited nonce information corresponding to the unlockable feature; and transmit an unlock grant to the aerosol-generating device to unlock the unlockable feature in response to the transmitted unlock request. It will be understood that references to the aerosol-generating device in the context of the actions performed by the server may be replaced or supplemented by references to the companion device and/or the aerosol-generating system and/or one or more external computing devices, as appropriate.

According to a sixth aspect, there is provided a method for performing an authentication process for authenticating a user of an aerosol-generating device. The aerosol-generating device has a locked state in which the aerosol-generating device is prohibited from delivering aerosol and an unlocked state in which the aerosol-generating device is permitted to deliver aerosol. The method may comprise, during an offline phase of the authentication process, permitting the user to make a first predetermined number of attempts to input valid authentication information using one or more user interface components. The method may further comprise, in response to receiving valid authentication information from the user before the first predetermined number of attempts has been exceeded, determining to transition the aerosol-generating device from the locked state to the unlocked state. The method may further comprise, in response to determining that the first predetermined number of attempts has been exceeded before the user has input valid authentication information, proceeding to an online phase of the authentication process.

The method may further comprise: responding to an unsuccessful attempt by the user to input valid authentication information during the offline phase by determining whether a second predetermined number of attempts has been exceeded, wherein the second predetermined number of attempts is lower than the first predetermined number of attempts; and, if the second predetermined number of attempts has been exceeded, delaying the offline phase until a first time delay period has expired. The method may comprise continuing the offline phase without delay if the second predetermined number of attempts has not been exceeded.

The method may further comprise: responding to an unsuccessful attempt by the user to input valid authentication information during the offline phase by determining whether a third predetermined number of attempts has been exceeded, wherein the third predetermined number of attempts is lower than the first predetermined number of attempts and higher than the second predetermined number of attempts; and, if the third predetermined number of attempts has been exceeded, delaying the offline phase until a second time delay period has expired. The method may further comprise continuing the offline phase without delay if the third predetermined number of attempts has not been exceeded. The second time delay period may be longer than the first time delay period.

The method may further comprise delaying the offline phase by prohibiting the user from inputting further authentication information using the one or more user interface components or by refraining from authenticating the user based on further authentication information input by the user.

The method may further comprise receiving, during each attempt of the offline phase, user-input authentication information from the one or more user interface components and authenticating the user by determining the validity of the user-input authentication information.

The method may further comprise receiving the user-input authentication information during multiple time windows of predetermined duration, each time window corresponding to a respective digit of a sequence of digits forming the authentication information, and attributing user input received via the one or more user interface components during a said time window to the digit corresponding to the said time window. The method may further comprise triggering a timeout in response to no user input being received by the one or more user interface components within a predetermined time period starting from the beginning of a respective one of the time windows. The method may further comprise initiating a first one of the time windows in response to a user interacting with the one or more user interface components. The method may further comprise initiating the first one of the time windows in response to receiving a predetermined signal generated by the user interacting with the one or more user interface components. The one or more user interface components may comprise a pushbutton. The predetermined signal may be generated by the user pressing the pushbutton a predetermined number of times. Before and/or during one or more of the time windows, there may be a preliminary time window. The method may further comprise determining that the attempt by the user to input valid authentication information was unsuccessful if no user-input authentication is received during the preliminary time window, and storing the received user-input authentication and initiating the corresponding time window and/or continuing running the corresponding time window if user-input authentication is received during the preliminary time window. The method may further comprise controlling the user interface components to output user-perceptible guidance signals indicating at least the beginnings of respective time windows. The method may further comprise controlling the user interface components to output user-perceptible guidance signals indicating that the said time window is running. The method may further comprise controlling the user interface components to output user-perceptible guidance signals indicating for which digit of the sequence the user is being guided to provide input. The aerosol-generating device may be provided with a number of output elements corresponding to the number of digits in the sequence. The method may further comprise using the position of an active output element with respect to inactive output elements to indicate the position of the digit within the sequence for which input is expected. The method may further comprise interpreting multiple signals arising from repeated user operation of a same said user interface component during a said time window as a coded input signal defining the digit of the sequence to which the said time window corresponds. The said user interface component may be a power button of the aerosol-generating device.

The method may further comprise, during the online phase of the authentication process: transmitting an unlock request to a server to transition the aerosol-generating device from the locked state to the unlocked state, wherein the unlock request comprises unique device-identification information identifying the aerosol-generating device and time-limited nonce information corresponding to an unlockable feature of the aerosol-generating device; receiving an unlock grant from the server in response to the transmitted unlock request; and transitioning the aerosol-generating device from the locked state to the unlocked state in response to reception of the unlock grant. The unlock grant may be at least partially encrypted. The method may further comprise decrypting the unlock grant using a public key stored on the aerosol-generating device.

The method may further comprise transitioning the aerosol-generating device from the locked state to the unlocked state in response to reception of the unlock grant by: decrypting the unlock grant; determining whether the decrypted unlock grant comprises the unique device identification information and the time-limited nonce information; and unlocking the unlockable feature in response to determination that the decrypted unlock grant comprises the unique device-identification information and the time-limited nonce information. The method may further comprise terminating unlocking the unlockable feature if the unlock grant is not received following a validity time period after the unlock request is transmitted to the server. The method may further comprise restricting a number of unlock grants transmitted to the aerosol-generating device. The unique device-identification may comprise a serial number.

The method may further comprise responding to an unsuccessful attempt by the user to input valid authentication information during the offline phase by determining not to transition the aerosol-generating device from the locked state to the unlocked state.

The method may further comprise determining the validity of user-input authentication information using a key derivation mechanism.

The method may be performed by the aerosol-generating device and/or by an aerosol-generating system comprising the aerosol-generating device and/or by a companion device for the aerosol-generating device. More particularly, the method may be performed by control circuitry of the aerosol-generating device, by control circuitry of the companion device, or by control circuitry of a system comprising the aerosol-generating device and the companion device. The method may be performed in a distributed way, with different steps of the method being performed by different components of the system. The method of the fifth aspect may be computer implemented.

According to a seventh aspect, there is provided a method performed by a server for performing the online phase of the authentication process in conjunction with the aerosol-generating device and/or the companion device and/or the aerosol-generating system and/or one or more other computing devices. More particularly, there is provided a method for unlocking an unlockable feature of an aerosol-generating device, the method comprising, by the server: receiving an unlock request from the aerosol-generating device to unlock the unlockable feature, wherein the unlock request comprises unique device identification information identifying the aerosol-generating device and time-limited nonce information corresponding to the unlockable feature; and transmitting an unlock grant to the aerosol-generating device to unlock the unlockable feature in response to the transmitted unlock request.

According to an eighth aspect, there is provided a computing system configured to perform the method of the sixth aspect and/or the seventh aspect.

According to a ninth aspect, there is provided a computer program comprising instructions which, when executed by a computing system, enable or cause the computing system to perform the method of the sixth aspect and/or the seventh aspect.

According to a tenth aspect, there is provided a computer-readable medium comprising instructions which, when executed by a computing system, enable or cause the computing system to perform the method of the sixth aspect and/or the seventh aspect. The computer-readable medium may be transitory or non-transitory, volatile or non-volatile.

As used herein, “offline” refers to a phase of the authentication process which is connectivity-free, connectivity-agnostic, or connectivity-independent, in the sense that the offline phase is performed while the aerosol-generating device or the aerosol-generating system comprising the aerosol-generating device is in a disconnected or offline state. In other words, “offline” refers to a phase of the authentication process in which the aerosol-generating device transitioning from the locked state to the unlocked state is not dependent on the control circuitry, aerosol-generating system or aerosol-generating device receiving signals from an external computing device. Additionally or alternatively, “offline” refers to a phase of the authentication process in which the device transitioning from the locked state to the unlocked state is not dependent on the control circuitry, aerosol-generating system or aerosol-generating device being connected (or “paired”) with an external computing device.

Correspondingly, the term “online phase” is to be construed as a phase of the authentication process which uses device connectivity for the purposes of performing the authentication process while the aerosol-generating device or the aerosol-generating system comprising the aerosol-generating device is in a connected or online state. The online phase and offline phase may alternatively be described in terms of an online modality and an offline modality, respectively. In other words, “online” refers to a phase of the authentication process in which the aerosol-generating device transitioning from the locked state to the unlocked state is dependent on the control circuitry, aerosol-generating system or aerosol-generating device receiving signals from an external computing device. Additionally or alternatively, “online” refers to a phase of the authentication process in which the device transitioning from the locked state to the unlocked state is dependent on the control circuitry, aerosol-generating system or aerosol-generating device being connected (or “paired”) with an external computing device.

For example, the control circuitry may be further configured to perform the offline phase of the authentication process without the aerosol-generating device (or any part of a system comprising the aerosol-generating device) being connected (or required to be connected) to an external computing device (e.g. a mobile phone, personal computer, or tablet device). Additionally or alternatively, the control circuitry may be further configured to perform the offline phase without transmitting authentication-relevant data to, or receiving authentication-relevant data from, an external computing device, even in the case that the aerosol-generating device is connected to the external computing device, “authentication-relevant data” comprising for example data that is used by or necessary for the authentication process. The control circuitry may be further configured to perform the offline phase without being controlled by, and/or without controlling, an external computing device. The control circuitry may be further configured to perform the offline phase without the aerosol-generating device being connected to or forming part of a network including one or more external computing devices, for example the internet. “Offline” may refer to any existing connectivity of the aerosol-generating device not being used for authentication-related purposes or tasks, regardless of whether the aerosol-generating device is connected/connectable to an external computing device. For example, “offline” may refer to a state or phase in which data exchanged during the authentication process by any communications interface of the aerosol-generating device which provide its connectivity not being input to, or output from, the control circuitry, or, more particularly, the threads or components thereof which are performing authentication-related tasks. In other words, the aerosol-generating device may comprise a communications interface for managing a connection to an external computing device, with “offline” indicating that, during the offline phase of the authentication process, the communications interface remains idle or performs only tasks unrelated to the authentication process.

It should be noted that the term “external computing device” when used in relation to the term “offline” does not include either the companion device or the aerosol-generating device, where authentication is performed by the other of those devices. Rather, in the context of the present disclosure, the term “external computing device” may refer to a computing device configured to communicate with the aerosol-generating device and/or the companion device, for example based on exchanging data or information. Generally, the external computing device may be a handheld or portable device. Alternatively, the external computing device may be a stand-alone or fixedly installed device. Further, the external computing device may be in possession of or may be installed at the user or another entity or individual, such as a retail shop. By way of example, the external computing device may refer to a handheld, a smart phone, a personal computer (“PC”), a tablet PC, a notebook, or a computer. The external computing device may comprise a user interface. The external computing device may comprise one or more processors for data processing, such as for processing one or more user inputs received at the user interface. Additionally or alternatively, the external computing device may comprise a data storage and/or memory for storing data, such as for example software instructions, a computer program, and/or other data. Further, the external computing device may comprise a communications interface, communications module and/or communications circuitry for communicatively coupling the external computing device with the aerosol-generating device and/or the companion device, for example via the communications interface thereof. Thus, the external computing device may be configured for wireless and/or wired communication with the aerosol-generating device, with the companion device, or both. For instance, the external computing device may be configured for being communicatively coupled with the aerosol-generating device and/or companion device via an Internet connection, a wireless LAN connection, a WiFi connection, a Bluetooth connection, a mobile phone network, a 3G/4G/5G connection and so on, an edge connection, an LTE connection, a BUS connection, a wireless connection, a wired connection, a radio connection, a near field connection, an IoT connection or any other connection using any appropriate communication protocol.

As used herein, the term “locked state” may refer to a locked configuration of the aerosol-generating device and the term “unlocked state” may refer to an unlocked configuration of the aerosol-generating device. In the locked state or configuration, the aerosol-generating device is prohibited from delivering and/or generating aerosol. This may mean that the aerosol-generating device is locked for aerosol consumption by the user in the locked state and/or that the aerosol-generating device is configured in the locked state, such that no aerosol can be delivered and/or generated. On the other hand, in the unlocked state or configuration, the aerosol-generating device is permitted or allowed to deliver and/or generate aerosol. This may mean that the aerosol-generating device is unlocked for consumption of aerosol by the user in the unlocked state and/or that the aerosol-generating device is configured in the unlocked state, such that aerosol can be delivered and/or generated. Accordingly, when the aerosol-generating device is in the locked state, the aerosol-generating device may not be actuatable by the user to deliver and/or generate aerosol, and, when the aerosol-generating device is in the unlocked state, the aerosol-generating device may be actuatable by the user to deliver and/or generate aerosol. In other words, in the locked state of the aerosol-generating device, access to one or more functions or functionalities of the aerosol-generating device, including aerosol delivery and/or generation, may be prohibited for the user, and in the unlocked state of the aerosol-generating device, access to one or more functions or functionalities of the aerosol-generating device, including aerosol delivery and/or generation, may be permitted for the user. Additionally or alternatively, the companion device may be configured to charge the energy storage of the aerosol-generating device only if there has been a successful authentication of the user. In this example, the locked state may be considered as the state in which the energy storage of the aerosol-generating device does not contain enough charge to cause aerosol to be generated, and the unlocked state may be considered as the state in which the energy storage contains enough charge to cause aerosol to be generated. The authentication signal may then be considered as the provision of charge to the energy storage of the aerosol-generating device by the companion device. In the locked state, the control circuitry may, for example, be configured to prohibit activation of a heating element based on at least one of disabling the at least one heating element, disabling an energy supply for supplying electrical energy to the at least one heating element, and disabling an input element for actuating the at least one heating element by the user.

As used herein, the term “transitioning” may mean entering, configuring and/or switching the aerosol-generating device into the locked or unlocked state, which may mean or comprise actuating and/or configuring the aerosol-generating device such that the aerosol-generating device is in the locked or unlocked state.

As used herein, the term “authentication” refers to verifying the identity of the user.

As used herein, the term “authorization” refers to determining the user's access rights, i.e., their right to transition the aerosol-generating device from the locked state to the unlocked state. Since, in the context of YAP methods, the user's identity is inherently bound to their access rights, the terms “authentication” and “authorization” may be used interchangeably in the present disclosure.

As used herein, the term “authorized user” (also referred to as a “verified user”) can refer to or denote a proprietor of the aerosol-generating device, an adult, an adult individual, a user of full age, a user having reached the age threshold, a user having reached majority age, and/or a user that has been authorized to configure the aerosol-generating device by another authorized user, such as by the proprietor. Further, an unauthorized user can refer to or denote an underage user, a user not having reached an age threshold, a child, or any other user who is unauthorized to configure the aerosol-generating device, in particular unauthorized to transition the aerosol-generating device into the unlocked state for aerosol consumption.

The term “circuitry”, as used herein, may comprise, for example, singly or in any combination, hardwired circuitry, programmable circuitry such as computer processors comprising one or more individual instruction processing cores, state machine circuitry, and/or firmware that stores instructions executed by programmable circuitry. Modules may, collectively or individually, be embodied as circuitry that forms a part of one or more devices or systems as described herein.

The term “obtaining”, as used herein, may comprise, for example, receiving from another system, device, or process; receiving via an interaction with a user; loading or retrieving from storage or memory; measuring or capturing using sensors or other data acquisition devices.

The term “determining”, as used herein, encompasses a wide variety of actions, and may comprise, for example, calculating, computing, processing, deriving, investigating, looking up (e.g., looking up in a table, a database or another data structure), ascertaining, and the like. Also, “determining” may comprise receiving (e.g., receiving information), accessing (e.g., accessing data in a memory), and the like. Also, “determining” may comprise resolving, selecting, choosing, establishing and the like.

The indefinite article “a” or “an” does not exclude a plurality. In addition, the articles “a” and “an” as used herein should generally be construed to mean “one or more” unless specified otherwise or clear from the context to be directed to a singular form.

Unless specified otherwise, or clear from the context, the phrases “one or more of A, B and C”, “at least one of A, B, and C”, and “A, B and/or C” as used herein are intended to mean all possible permutations of one or more of the listed items. That is, the phrase “A and/or B” means (A), (B), or (A and B), while the phrase “A, B, and/or C” means (A), (B), (C), (A and B), (A and C), (B and C), or (A, B, and C).

The term “comprising” does not exclude other elements or steps. Furthermore, the terms “comprising”, “including”, “having” and the like may be used interchangeably herein.

Below, there is provided a non-exhaustive list of non-limiting examples. Any one or more of the features of these examples may be combined with any one or more features of another example, embodiment, or aspect described herein.

Ex. 1. Control circuitry for an aerosol-generating device or for an aerosol-generating system comprising the aerosol-generating device, the aerosol-generating device having a locked state in which the aerosol-generating device is prohibited from delivering aerosol and an unlocked state in which the aerosol-generating device is permitted to deliver aerosol, the control circuitry being configured to perform an authentication process for authenticating the user, the control circuitry being configured to:

during an offline phase of the authentication process, permit the user to make a first predetermined number of attempts to input valid authentication information using one or more user interface components;

in response to receiving valid authentication information from the user before the first predetermined number of attempts has been exceeded, determine to transition the aerosol-generating device from the locked state to the unlocked state; and

in response to determining that the first predetermined number of attempts has been exceeded before the user has input valid authentication information, proceed to an online phase of the authentication process.

Ex. 2. The control circuitry of Ex. 1, configured to:

respond to an unsuccessful attempt by the user to input valid authentication information during the offline phase by determining whether a second predetermined number of attempts has been exceeded, wherein the second predetermined number of attempts is lower than the first predetermined number of attempts; and

if the second predetermined number of attempts has been exceeded, to delay the offline phase until a first time delay period has expired.

Ex. 3. The control circuitry of Ex. 2, configured to continue the offline phase without delay if the second predetermined number of attempts has not been exceeded.

Ex. 4. The control circuitry of Ex. 2 or Ex. 3, configured to:

respond to an unsuccessful attempt by the user to input valid authentication information during the offline phase by determining whether a third predetermined number of attempts has been exceeded, wherein the third predetermined number of attempts is lower than the first predetermined number of attempts and higher than the second predetermined number of attempts; and

if the third predetermined number of attempts has been exceeded, to delay the offline phase until a second time delay period has expired.

Ex. 5. The control circuitry of Ex. 4, configured to continue the offline phase without delay if the third predetermined number of attempts has not been exceeded.

Ex. 6. The control circuitry of Ex. 4 or Ex. 5, wherein the second time delay period is longer than the first time delay period.

Ex. 7. The control circuitry of any of Ex. 2-Ex. 6, configured to delay the offline phase by prohibiting the user from inputting further authentication information using the one or more user interface components or by refraining from authenticating the user based on further authentication information input by the user.

Ex. 8. The control circuitry of any of Ex. 1-Ex. 7, configured to receive, during each attempt of the offline phase, user-input authentication information from the one or more user interface components and to authenticate the user by determining the validity of the user-input authentication information.

Ex. 9. The control circuitry of Ex. 8, configured to receive the user-input authentication information during multiple time windows of predetermined duration, each time window corresponding to a respective digit of a sequence of digits forming the authentication information, and to attribute user input received via the one or more user interface components during a said time window to the digit corresponding to the said time window.

Ex. 10. The control circuitry of Ex. 9, configured to trigger a timeout in response to no user input being received by the one or more user interface components within a predetermined time period starting from the beginning of a respective one of the time windows.

Ex. 11. The control circuitry of Ex. 9 or Ex. 10, configured to initiate a first one of the time windows in response to a user interacting with the one or more user interface components.

Ex. 12. The control circuitry of Ex. 11, configured to initiate the first one of the time windows in response to receiving a predetermined signal generated by the user interacting with the one or more user interface components.

Ex. 13. The control circuitry of Ex. 12, wherein the one or more user interface components comprise a pushbutton, and the predetermined signal is generated by the user pressing the pushbutton a predetermined number of times.

Ex. 14. The control circuitry of any of Ex. 9-Ex. 13, wherein before and/or during one or more of the time windows, there is a preliminary time window, and wherein the control circuitry is configured to determine that the attempt by the user to input valid authentication information was unsuccessful if no user-input authentication is received during the preliminary time window, and to store the received user-input authentication and to initiate the corresponding time window and/or to continue running the corresponding time window if user-input authentication is received during the preliminary time window.

Ex. 15. The control circuitry of any of Ex. 9-Ex. 14, configured to control the user interface components to output user-perceptible guidance signals indicating at least the beginnings of respective time windows.

Ex. 16. The control circuitry of any of Ex. 9-Ex. 15, configured to control the user interface components to output user-perceptible guidance signals indicating that the said time window is running.

Ex. 17. The control circuitry of any of Ex. 9-Ex. 16, configured to control the user interface components to output user-perceptible guidance signals indicating for which digit of the sequence the user is being guided to provide input.

Ex. 18. The control circuitry of Ex. 17, wherein the aerosol-generating device is provided with a number of output elements corresponding to the number of digits in the sequence, and wherein the control circuitry is configured to use the position of an active output element with respect to inactive output elements to indicate the position of the digit within the sequence for which input is expected.

Ex. 19. The control circuitry of any of Ex. 9-Ex. 18, configured to interpret multiple signals arising from repeated user operation of a same said user interface component during a said time window as a coded input signal defining the digit of the sequence to which the said time window corresponds.

Ex. 20. The control circuitry of Ex. 19, wherein the said user interface component is a power button of the aerosol-generating device.

Ex. 21. The control circuitry of any of Ex. 1-Ex. 20, configured, during the online phase of the authentication process, to:

transmit an unlock request to a server to transition the aerosol-generating device from the locked state to the unlocked state, wherein optionally the unlock request comprises unique device-identification information identifying the aerosol-generating device and/or time-limited nonce information corresponding to an unlockable feature of the aerosol-generating device;

receive an unlock grant from the server in response to the transmitted unlock request; and

transition the aerosol-generating device from the locked state to the unlocked state in response to reception of the unlock grant.

Ex. 22. The control circuitry of Ex. 21, wherein the unlockable feature comprises the ability to use a heating element of the aerosol-generating device to heat an aerosol-generating article to generate aerosol therefrom.

Ex. 23. The control circuitry of Ex. 21 or Ex. 22, wherein the unlock grant is at least partially encrypted.

Ex. 24. The control circuitry of Ex. 23, wherein the unlock grant is decryptable using a public key stored on the aerosol-generating device.

Ex. 25. The control circuitry of any of Ex. 21-Ex. 24, configured to transition the aerosol-generating device from the locked state to the unlocked state in response to reception of the unlock grant by: decrypting the unlock grant; determining whether the decrypted unlock grant comprises the unique device identification information and the time-limited nonce information; and unlocking the unlockable feature in response to determination that the decrypted unlock grant comprises the unique device-identification information and the time-limited nonce information.

Ex. 26. The control circuitry of any of Ex. 21-Ex. 25, configured to terminate unlocking the unlockable feature if the unlock grant is not received following a validity time period after the unlock request is transmitted to the server.

Ex. 27. The control circuitry of any of Ex. 21-Ex. 26, configured to restrict a number of unlock grants transmitted to the aerosol-generating device.

Ex. 28. The control circuitry of any of Ex. 21-Ex. 27, wherein the unique device-identification comprises a serial number.

Ex. 29. The control circuitry of any of Ex. 1-Ex. 28, wherein the authentication process comprises a youth access prevention process.

Ex. 30. The control circuitry of any of Ex. 1-Ex. 29, configured to respond to an unsuccessful attempt by the user to input valid authentication information during the offline phase by determining not to transition the aerosol-generating device from the locked state to the unlocked state.

Ex. 31. The control circuitry of any of Ex. 1-Ex. 30, configured to determine the validity of user-input authentication information using a key derivation mechanism.

Ex. 32. An aerosol-generating device comprising the control circuitry of any of Ex. 1-Ex. 31.

Ex. 33. An aerosol-generating system comprising the control circuitry of any of Ex. 1-Ex. 31 and the aerosol-generating device.

Ex. 34. A companion device for an aerosol-generating device, the companion device comprising the control circuitry of any of Ex. 1-Ex. 31.

Ex. 35. A method for performing an authentication process for authenticating a user of an aerosol-generating device, the aerosol-generating device having a locked state in which the aerosol-generating device is prohibited from delivering aerosol and an unlocked state in which the aerosol-generating device is permitted to deliver aerosol, the method comprising:

during an offline phase of the authentication process, permitting the user to make a first predetermined number of attempts to input valid authentication information using one or more user interface components;

in response to receiving valid authentication information from the user before the first predetermined number of attempts has been exceeded, determining to transition the aerosol-generating device from the locked state to the unlocked state; and

in response to determining that the first predetermined number of attempts has been exceeded before the user has input valid authentication information, proceeding to an online phase of the authentication process.

Ex. 36. The method of Ex. 35, comprising:

responding to an unsuccessful attempt by the user to input valid authentication information during the offline phase by determining whether a second predetermined number of attempts has been exceeded, wherein the second predetermined number of attempts is lower than the first predetermined number of attempts; and

if the second predetermined number of attempts has been exceeded, delaying the offline phase until a first time delay period has expired.

Ex. 37. The method of Ex. 36, comprising continuing the offline phase without delay if the second predetermined number of attempts has not been exceeded.

Ex. 38. The method of Ex. 36 or Ex. 37, comprising:

responding to an unsuccessful attempt by the user to input valid authentication information during the offline phase by determining whether a third predetermined number of attempts has been exceeded, wherein the third predetermined number of attempts is lower than the first predetermined number of attempts and higher than the second predetermined number of attempts; and

if the third predetermined number of attempts has been exceeded, delaying the offline phase until a second time delay period has expired.

Ex. 39. The method of Ex. 38, comprising continuing the offline phase without delay if the third predetermined number of attempts has not been exceeded.

Ex. 40. The method of Ex. 38 or Ex. 39, wherein the second time delay period is longer than the first time delay period.

Ex. 41. The method of any of Ex. 36-Ex. 40, comprising delaying the offline phase by prohibiting the user from inputting further authentication information using the one or more user interface components or by refraining from authenticating the user based on further authentication information input by the user.

Ex. 42. The method of any of Ex. 35-Ex. 41, comprising receiving, during each attempt of the offline phase, user-input authentication information from the one or more user interface components and authenticating the user by determining the validity of the user-input authentication information.

Ex. 43. The method of Ex. 42, comprising receiving the user-input authentication information during multiple time windows of predetermined duration, each time window corresponding to a respective digit of a sequence of digits forming the authentication information, and attributing user input received via the one or more user interface components during a said time window to the digit corresponding to the said time window.

Ex. 44. The method of Ex. 43, comprising triggering a timeout in response to no user input being received by the one or more user interface components within a predetermined time period starting from the beginning of a respective one of the time windows.

Ex. 45. The method of Ex. 43 or Ex. 44, comprising initiating a first one of the time windows in response to a user interacting with the one or more user interface components.

Ex. 46. The method of Ex. 45, comprising initiating the first one of the time windows in response to receiving a predetermined signal generated by the user interacting with the one or more user interface components.

Ex. 47. The method of Ex. 46, wherein the one or more user interface components comprise a pushbutton, and the predetermined signal is generated by the user pressing the pushbutton a predetermined number of times.

Ex. 48. The method of any of Ex. 43-Ex. 47, wherein before and/or during one or more of the time windows, there is a preliminary time window, the method further comprising determining that the attempt by the user to input valid authentication information was unsuccessful if no user-input authentication is received during the preliminary time window, and storing the received user-input authentication and initiating the corresponding time window and/or continuing running the corresponding time window if user-input authentication is received during the preliminary time window.

Ex. 49. The method of any of Ex. 43-Ex. 48, comprising controlling the user interface components to output user-perceptible guidance signals indicating at least the beginnings of respective time windows.

Ex. 50. The method of any of Ex. 43-Ex. 49, comprising controlling the user interface components to output user-perceptible guidance signals indicating that the said time window is running.

Ex. 51. The method of any of Ex. 43-Ex. 50, comprising controlling the user interface components to output user-perceptible guidance signals indicating for which digit of the sequence the user is being guided to provide input.

Ex. 52. The method of Ex. 51, wherein the aerosol-generating device is provided with a number of output elements corresponding to the number of digits in the sequence, the method further comprising using the position of an active output element with respect to inactive output elements to indicate the position of the digit within the sequence for which input is expected.

Ex. 53. The method of any of Ex. 43-Ex. 52, comprising interpreting multiple signals arising from repeated user operation of a same said user interface component during a said time window as a coded input signal defining the digit of the sequence to which the said time window corresponds.

Ex. 54. The method of Ex. 53, wherein the said user interface component is a power button of the aerosol-generating device.

Ex. 55. The method of any of Ex. 35-Ex. 54, comprising, during the online phase of the authentication process:

transmitting an unlock request to a server to transition the aerosol-generating device from the locked state to the unlocked state, wherein the unlock request comprises unique device-identification information identifying the aerosol-generating device and time-limited nonce information corresponding to an unlockable feature of the aerosol-generating device;

receiving an unlock grant from the server in response to the transmitted unlock request; and

transitioning the aerosol-generating device from the locked state to the unlocked state in response to reception of the unlock grant.

Ex. 56. The method of Ex. 55, wherein the unlockable feature comprises the ability to use a heating element of the aerosol-generating device to heat an aerosol-generating article to generate aerosol therefrom.

Ex. 57. The method of Ex. 55 or Ex. 56, wherein the unlock grant is at least partially encrypted.

Ex. 58. The method of Ex. 57, comprising decrypting the unlock grant using a public key stored on the aerosol-generating device.

Ex. 59. The method of any of Ex. 55-Ex. 58, comprising transitioning the aerosol-generating device from the locked state to the unlocked state in response to reception of the unlock grant by: decrypting the unlock grant; determining whether the decrypted unlock grant comprises the unique device identification information and the time-limited nonce information; and unlocking the unlockable feature in response to determination that the decrypted unlock grant comprises the unique device-identification information and the time-limited nonce information.

Ex. 60. The method of any of Ex. 55-Ex. 59, comprising terminating unlocking the unlockable feature if the unlock grant is not received following a validity time period after the unlock request is transmitted to the server.

Ex. 61. The method of any of Ex. 55-Ex. 60, comprising restricting a number of unlock grants transmitted to the aerosol-generating device.

Ex. 62. The method of any of Ex. 55-Ex. 61, wherein the unique device-identification comprises a serial number.

Ex. 63. The method of any of Ex. 35-Ex. 62, wherein the authentication process comprises a youth access prevention process.

Ex. 64. The method of any of Ex. 35-Ex. 63, comprising responding to an unsuccessful attempt by the user to input valid authentication information during the offline phase by determining not to transition the aerosol-generating device from the locked state to the unlocked state.

Ex. 65. The method of any of Ex. 35-Ex. 64, comprising determining the validity of user-input authentication information using a key derivation mechanism.

Ex. 66. The method of any of Ex. 35-Ex. 65, performed by the aerosol-generating device.

Ex. 67. The method of any of Ex. 35-Ex. 66, performed by an aerosol-generating system comprising the aerosol-generating device.

Ex. 68. The method of any of Ex. 35-Ex. 67, performed by a companion device for the aerosol-generating device.

Ex. 69. A computer program comprising instructions which, when executed by a computing system, cause the computing system to perform the method of any of Ex. 35-Ex. 68.

Ex. 70. A computer-readable medium comprising instructions which, when executed by a computing system, cause the computing system to perform the method of any of Ex. 35-Ex. 68.

The invention may include one or more aspects, examples or features in isolation or combination whether specifically disclosed in that combination or in isolation. Any optional feature or sub-aspect of one of the above aspects applies as appropriate to any of the other aspects.

Examples will now be further described with reference to the drawings in which:

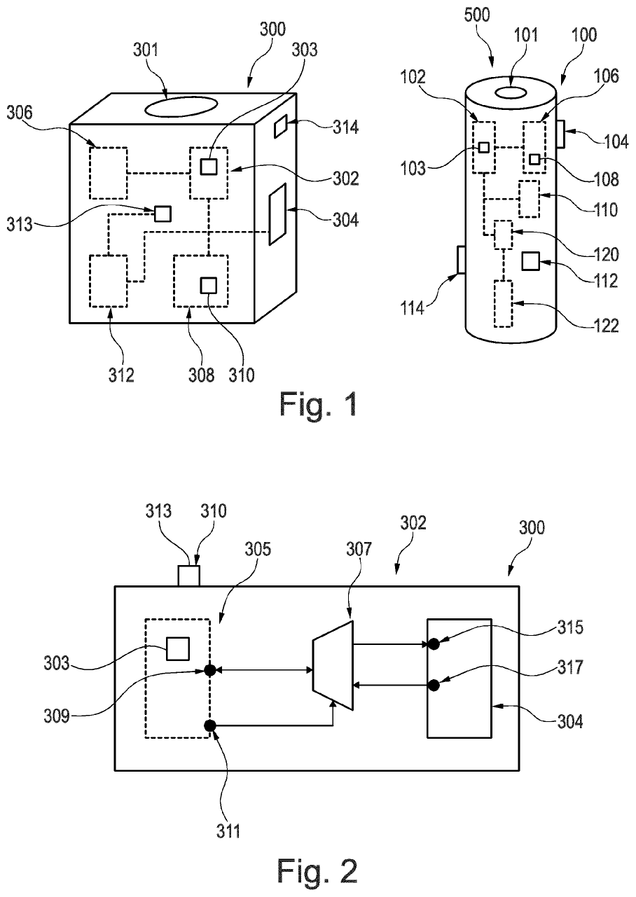

FIG. 1 schematically illustrates an aerosol-generating system comprising an aerosol-generating device;

FIG. 2 schematically illustrates part of a companion device in the aerosol-generating system of FIG. 1;

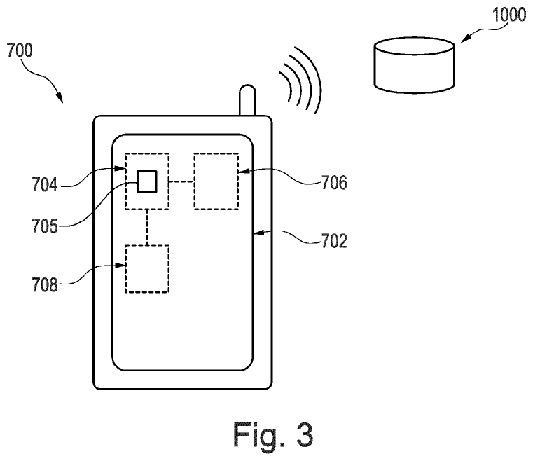

FIG. 3 schematically illustrates an external computing device for use in conjunction with the aerosol-generating system of FIG. 1;

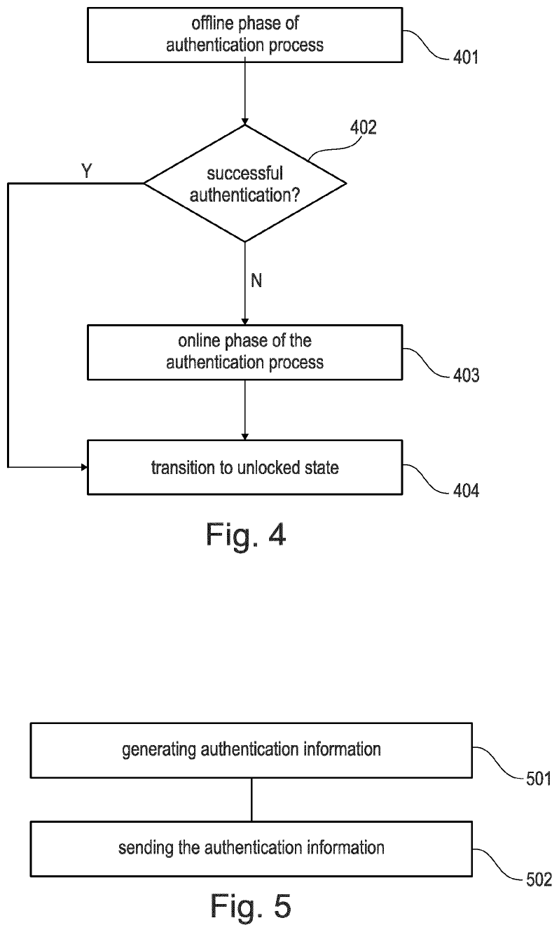

FIG. 4 is a flowchart illustrating an authentication process for authenticating a user of the aerosol-generating device of FIG. 1;

FIG. 5 is a flowchart illustrating a method of generating authentication information and sending it to the user; and

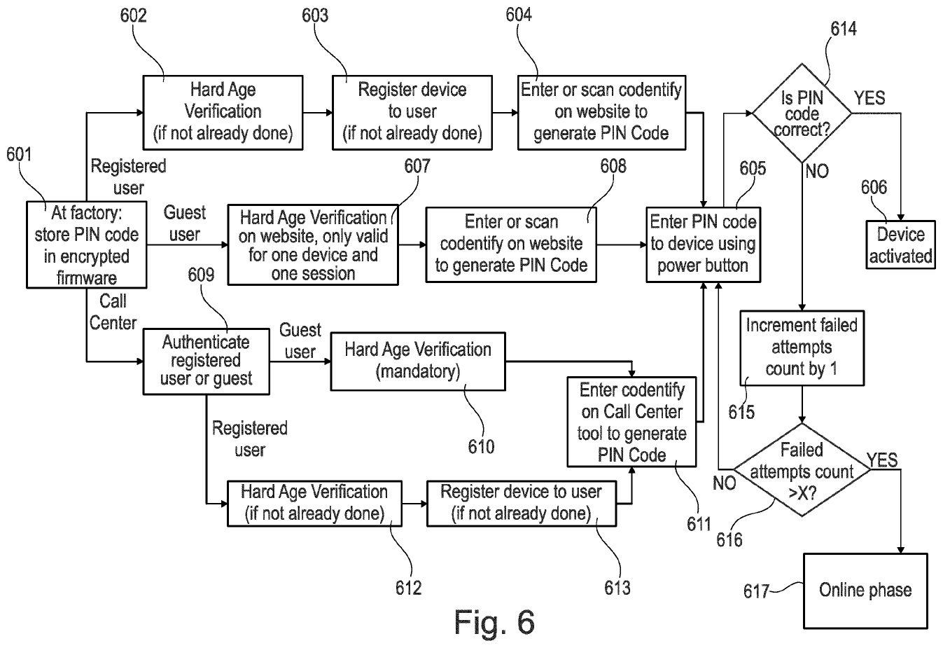

FIG. 6 is a flowchart illustrating a method of device activation including steps from preparation in the factory to user activation.

The drawings are schematic only and not true to scale.

FIG. 1 shows an aerosol-generating system 500 for generating aerosol, for example for consumption by a user. The system 500 comprises an aerosol-generating device 100 for generating aerosol and a companion device 300 for at least partially receiving the aerosol-generating device 100 and for charging the aerosol-generating device 100.

The aerosol-generating device 100 comprises an insertion opening 101 for at least partially inserting an aerosol-generating article (not shown). The aerosol-generating article may comprise an aerosol-forming substrate, such as a tobacco containing substrate, and/or a cartridge comprising a liquid. The aerosol-forming substrate may comprise nicotine.

The aerosol-generating device 100 further includes control circuitry 102 with one or more processors 103. The control circuitry 102 may be configured to control actuation, activation and/or deactivation of the at least one heating element 120.

The aerosol-generating device 100 further comprises user interface components comprising an input element in the form of a pushbutton 104. The pushbutton 104 is actuatable by the user to input a pin code to the control circuitry 102, as described further below. Following successful completion of the authentication process, the pushbutton 104 may furthermore be used as a power button to activate or deactivate the heating element 120 for aerosol generation thereby to activate or deactivate the aerosol-generating device 100. The pushbutton 104 may also comprise output elements (e.g. one or more waveguides that communicate light from LED(s)) for indicating a state of the device 100 to a user. These options simplify the device 100. Upon activation of the aerosol-generating device 100, the heating element 120 may be activated and heat may be applied to at least a part of the aerosol-generating article, such that aerosol can be generated for consumption by the user. Upon deactivation of the aerosol-generating device 100, the heating element 120 may be deactivated such that no or reduced heat may be applied to the at least a part of the aerosol-generating article, such that no aerosol can be generated for consumption by the user. The user interface components further comprise output elements in the form of an LED array 112 (or a single LED) and/or a haptic output element (not shown) for providing haptic pulses. The output elements provide user-perceptible guidance signals to the user. The LED array 112 may furthermore be used for indicating a charge level of the at least one energy storage 122, indicating that the at least one energy storage should be charged, or the like, for example. The LED array 112 may also be used for indicating a configuration or state of the aerosol-generating device 100, for example whether the aerosol-generating device is in a locked or unlocked state.

The aerosol-generating device 100 further comprises a communications system 106 with one or more communications interfaces 108 for communicatively coupling the aerosol-generating device 100 with the companion device 300, for example, via an Internet connection, a wireless LAN connection, a WiFi connection, a Bluetooth connection, a mobile phone network, a 3G/4G/5G connection, an edge connection, an LTE connection, a BUS connection, a wireless connection, a wired connection, a radio connection, a near field connection, and/or an IoT connection.

The aerosol-generating device 100 further comprises a data storage 110 for storing information or data, such as at least one authentication indicator and/or other data.

The aerosol-generating device 100 further comprises at least one electrical connector 114 for coupling to a corresponding at least one electrical connector 313 of the companion device 300. For example, when the aerosol-generating device 100 is at least partially inserted into the opening 301 of the companion device 300, the one or more electrical connectors 114 of the aerosol-generating device 100 may be coupled with the one or more electrical connectors 313 of the companion device 300 to charge the at least one energy storage 122 of the aerosol-generating device 100.

For generating the aerosol during use or consumption of the aerosol-generating article, the aerosol-generating device 100 comprises at least one heating element 120 or heat source 120 for applying heat to at least a portion of the aerosol-generating article.

For powering the at least one heating element 120 with electrical power, the aerosol-generating device 100 further comprises at least one energy storage 122 or energy supply 122 for storing electrical energy or power.

The aerosol-generating device 100 has a locked state in which the aerosol-generating device 100 is prohibited from delivering aerosol and an unlocked state in which the aerosol-generating 100 is permitted to deliver aerosol.

In use, the control circuitry 102 is configured to: during an offline phase of an authentication process, permit the user to make a first predetermined number of attempts to input valid authentication information using one or more user interface components; in response to receiving valid authentication information from the user before the first predetermined number of attempts has been exceeded, determine to transition the aerosol-generating device from the locked state to the unlocked state; in response to determining that the first predetermined number of attempts has been exceeded before the user has input valid authentication information, proceed to an online phase of the authentication process.

One non-limiting example of the authentication process will now be described. In this non-limiting example, the authentication process comprises a YAP process which transitions from the offline phase to the online phase after many failed attempts. In this non-limiting example, the user uses the pushbutton 104 to input a four-digit pin code (with each digit ranging from 1 to 9). Once the pin has been entered incorrectly too many times, the user has to connect the aerosol-generating device 100 to an external computing device such as a smartphone by Bluetooth or a personal computer by USB. This allows the user to proceed with the online phase of the YAP process using a website provided for that purpose. Once the age verification process is successfully performed on the website, the aerosol-generating device 100 is automatically unlocked.

To enter the offline phase of the YAP process, the user presses the pushbutton 104 five times within a period of 3 seconds. The aerosol-generating device 100 reacts with a 1 second haptic pulse and a first LED of the LED array 112 (referred to hereinafter as LED1) starts blinking to indicate to the user that the first digit must be entered into the aerosol-generating device 100. Thus, the first LED (LED1) corresponds to the first digit of the pin code. In this way, the control circuitry 102 controls the LED array 112 to indicate for which digit of the pin code the user is being guided to provide input. Additionally, the blinking of LED1 indicates to the user that a first time window is running during which the first digit should be entered. The beginning of the blinking indicates the start of the time window. The control circuitry 102 interprets multiple signals arising from repeated user operation of the pushbutton 104 during the first time window as a coded input signal defining the first digit of the pin code. In one illustrative example, if the user wishes to enter the pin code 3521, the pushbutton 104 has to be pressed three times while LED1 is blinking during the first time window. The three signals resulting from the repeated presses of the pushbutton 104 during the first time window define a coded input signal which is interpreted by the control circuitry 102 as the digit “3”. Having been received during the first time window, this digit is attributed by the control circuitry 102 correspondingly to the first digit of the pin code.

To leave enough time for the user to start pressing the pushbutton 104, a double timeout is implemented. A first timeout is configured at 15 seconds to leave enough time for the user to understand the process. If the pushbutton 104 is not pressed within these first 15 seconds, the control circuitry determines not to transition the device 100 to the unlocked state. In one example, the device 100 switches off in response to the triggering of the first timeout. Once the pushbutton 104 is pressed once (before expiry of the first timeout), the second timeout starts and the user has a further 7 seconds to complete the first digit before the first time window ends. The end of the first time window defines the point at which the control circuitry 102 no longer attributes received user input to the first digit.

At the end of the first time window, LED1 switches off and LED2 starts blinking to indicate that the user is being guided to enter the second digit during a second time window having a predetermined duration of 7 seconds. While LED2 is blinking during the second time window, the user has to press the pushbutton 104 five times (for the exemplary pin code 3521) to generate a coded input signal defining the second digit of the pin code.

At the end of the second time window, LED2 switches off and LED3 starts blinking to invite the user to enter the third digit. Continuing with the exemplary pin code 3521, while the LED3 is blinking during the 7-second third time window, the user has to press the pushbutton 104 two times.

At the end of the third time window, LED3 switches off and LED4 starts blinking to invite the user to enter the fourth and final digit. Following the example above, while LED4 is blinking, the user has to press the pushbutton 104 only one time. At the end of the fourth time window, LED4 switches off and all the LEDs start to blink simultaneously for 3 seconds.

In this way, the control circuitry 102 receives the user input during multiple time windows of predetermined duration. Each time window corresponds to a respective digit of the pin code: the first time window corresponds to the first digit, the second time window corresponds to the second digit, and so on. The control circuitry 102 attributes user input received via the pushbutton 104 during one of time windows to the digit corresponding to that time window: user input received during the first time window is attributed to the first digit, user input received during the second time window is attributed to the second digit, and so on.

Following the end of the final time window, the control circuitry 102 compares the user-input pin code with a prestored reference pin code and determines, based on an outcome of the comparison, whether to transition the aerosol-generating device 100 from the locked state to the unlocked state. If the pin code was entered successfully, the device 100 is transitioned to the unlocked state and the device 100 becomes usable. If the pin was entered wrongly, the control circuitry 102 determines not to transition the aerosol-generating device 100 from the locked state to the unlocked state, and permits further attempts according to the following protocol:

After 5 failed attempts, the user has to wait 5 minutes;

After 5 more failed attempts, the user has to wait 20 minutes;

After 5 more failed attempts, the user has to proceed to the online phase of the YAP process. The offline phase of the YAP process thereby comes to an end and the aerosol-generating device 100 can only be unlocked during the online phase.

In one non-limiting example, the online phase of the YAP process comprises the following steps:

1. The device 100 transmits to the server 1000 an unlock request comprising unique device-identification information such as its serial number and nonce information corresponding to an unlockable feature of the aerosol-generating device 100.

2. If the user is authorized, the device 100 receives from the server 1000 an unlock grant which is at least partially encrypted.

3. The device 100 decrypts the unlock grant using a public key stored on the aerosol-generating device 100.

4. The device 100 determines whether the decrypted unlock grant comprises the unique device identification information and the nonce information.

5. If so, the device 100 transitions from the locked state to the unlocked state.

In a variant to this example, the nonce information is time-limited, such that the process is terminated and optionally restarted from step 1 if the unlock grant is not received following a validity time period after the unlock request is transmitted to the server.

In a further non-limiting example, the online phase of the YAP process comprises the following steps:

1. The server 1000 (shown in FIG. 3) requests the current status of the feature it wishes to lock or unlock.

2. The aerosol-generating device 100 replies with the feature status.

3. If the server 1000 wishes to change the feature status, it requests unique information of the aerosol-generating device 100 such as its serial number.

4. The aerosol-generating device 100 sends this to the server 1000.

5. Next, the server 1000 requests that the aerosol-generating device 100 generate a unique value (nonce) related to the feature to lock or unlock.

6. The aerosol-generating device 100 generates the nonce and sends it to the server 1000.

7. The aerosol-generating device 100 initiates a validity timer during which the unlock process must be completed. If the procedure is unsuccessful or not completed within the validity time, the current process is invalidated and restarted from step 1.

8. The server 1000 creates a string (referred to hereinafter as “the message”) consisting of a lock/unlock request, the unique information of the aerosol-generating device 100, the nonce and some additional padding.

9. The server 1000 encrypts the message using an asymmetric private key and sends the result (the encrypted message) to the aerosol-generating device 100.

10. The aerosol-generating device 100 receives the encrypted message and decrypts it using the public key of the server 1000 (which is stored on the aerosol-generating device 100).

11. The aerosol-generating device 100 verifies that the decrypted message respects a predefined format and contains the original nonce, the unique device information and requests a change in status of the feature associated with the nonce.

If all of the above conditions are met, and the validity timer has not been exceeded, then the aerosol-generating device 100 changes the status of the feature. If not then the process is invalid and must be restarted from step 1.

In any of the above-described non-limiting examples, the pin code may be generated by a key derivation mechanism (not shown) on the aerosol-generating device 100. The key derivation mechanism is symmetric, meaning that the server generates the same pin code as the aerosol-generating device 100.

It will be understood that the above operations which were described as being carried out under control of the control circuitry 102 of the aerosol-generating device 100 could equally be carried out by the control circuitry 302 of the companion device 100 (as described below), or by the system 500 as a whole with the control being distributed between the control circuitry 102 of the aerosol-generating device 100 and the control circuitry 302 of the companion device 300. Moreover, the user interface components used for input and output of information may comprise those of the aerosol-generating device 100, those of the companion device 300 (as described below), or any combination of input and output elements of the aerosol-generating device 100 and companion device 300. To illustrate these possibilities further, the companion device 300 will now be described.

The companion device 300 may be configured for physically coupling the aerosol-generating device 100. For at least partially receiving the aerosol-generating device 100 and/or for physically coupling the aerosol-generating device 100 with the companion device 300, the companion device 300 includes an opening 301 or receiving opening 301, into which the aerosol-generating device 100 can be at least partially inserted, for example for storing and/or supporting the aerosol-generating device 100. Optionally, the companion device 300 may include a cover for opening and closing the opening 301. Additionally or alternatively, the companion device 300 may be configured to at least partially receive the aerosol-generating device 100 based on coupling the aerosol-generating device 100 to a mechanical attachment or coupling mechanism of the companion device 300, for example a hook mechanism, a latch mechanism, a snap-fit, or the like. Additionally or alternatively, the companion device 300 may be configured to at least partially receive the aerosol-generating device 100 based on coupling the aerosol-generating device 100 with the companion device 300 by means of a magnetic or electromagnetic coupling. For this purpose, the companion device 300 comprises a charger module 312 or charger circuitry 312 coupled to the electrical connector 313. The charger module 312 may, for example, be coupled to a supply grid for supplying the energy storage 122 of the aerosol-generating device 100 with electrical energy. Additionally or alternatively, the companion device 300 may comprise one or more batteries, accumulators, capacitors or the like. The companion device 300 comprises user interface components comprising a pushbutton 304 and a visual indicator 314, such as e.g. one or more LEDs 314 and/or an LED array 314. The companion device 300 further comprises a data storage 306 for storing information or data, such as an authentication indicator, reference authentication information, and/or other data. The control circuitry 302, data storage 306 and user interface components may be embodied in a single unit. In this way, it is possible for the user to be authenticated without the authentication information leaving the single unit, thus improving security. The companion device 300 further comprises a communication arrangement 308 with one or more communications interfaces 310 for communicatively coupling the companion device 300 with the aerosol-generating device 100, for example, via an Internet connection, a wireless LAN connection, a WiFi connection, a Bluetooth connection, a mobile phone network, a 3G/4G/5G connection, an edge connection, an LTE connection, a BUS connection, a wireless connection, a wired connection, a radio connection, a near field connection, and/or an IoT connection.

The companion device 300 further comprises control circuitry 302 with one or more processors 303. The control circuitry 302 may be configured to control the charger module 312 and/or other components or functions of the companion device 300. It should be noted that also the charger circuitry or module 312 may be combined with or included in the control circuitry 302. The control circuitry may be configured to perform the authentication process as described herein. Thus, the user performs the offline phase of the authentication process by interacting with the companion device 300, rather than with the aerosol-generating device 100. The control circuitry 302 may unlock or lock the aerosol-generating device in a variety of different ways following a successful authentication of the user, for instance by sending an unlocking signal to the aerosol-generating device.

FIG. 2 is a block diagram showing the companion device 300 in more detail. Specifically, FIG. 2 schematically shows at least a part 305 of the control circuitry 302, which includes the at least one processor 303 and which is coupled with the pushbutton 304 via a multiplexer 307. Therein, the part 305 may be coupled with or comprise the charger circuitry 312 and/or other electrical components of the companion device 300. For example, the at least part 305 of the control circuitry 302 exemplary shown in FIG. 2 may refer to a main controller 305 of the companion device 300. Further, a port 309, such as a one-wire MT communication port (referred to as “MTRTX” port), may be used for coupling the control circuitry 302 to the multiplexer 307. This one-wire communication may be converted via the multiplexer 307 to a two-wire communication. For example, signals can be transmitted from the multiplexer 307 to an input port 315 (such as an RX port) of the pushbutton 304, and signals can be transmitted from an output port 317 (such as a TX port) of the pushbutton 304 to the multiplexer 307. Therein, the multiplexer 307 may be controlled by the control circuitry 302 via a port 311. Further, in the example shown in FIG. 2, at least one communications interface 310 is combined with or integrated in the electrical connector 313, such that an electrical connection for charging the energy storage 122 of the aerosol-generating device 100 and a communicative coupling between the aerosol-generating device 100 and the companion device 300 can be established via the electrical connector(s) 114 of the aerosol-generating device 100 and the connector(s) 313 of the companion device.

FIG. 3 shows an external computing device 700 which may or may not be used in conjunction with the aerosol-generating system 500. The external computing device 700 comprises a user interface 702, control circuitry 704 comprising one or more processors 705 for data processing, a communications interface 706 for communicatively coupling the external computing device 700 to one or more of a server 1000 or the aerosol-generating system 500, and a data storage 708 for storing data or information.

FIG. 4 shows a flowchart illustrating a method for performing an authentication process for authenticating the user of the aerosol-generating device 100. Unless stated otherwise, the aerosol-generating device 100 comprises the same features, elements and/or functions as described elsewhere herein. Step 401 comprises performing the offline phase of the authentication process, during which the user is permitted to make a first predetermined number of attempts to input valid authentication information. Step 402 comprises determining whether a successful authentication has been achieved during the offline phase. That is, whether valid authentication information has been received from the user before the first predetermined number of attempts has been exceeded. If so, the method proceeds to step 404, at which a determination is made to transition the aerosol-generating device 100 from the locked state to the unlocked state. Otherwise, the method proceeds to the online phase of the authentication process in step 403. Following successful resolution of the online phase, the method again proceeds to step 404. Otherwise, as described above, the online phase may be repeated. The method illustrated in FIG. 4 can comprise numerous alternative or additional steps as described elsewhere herein.

FIG. 5 shows a flowchart illustrating a method in which step 501 comprises generating authentication information for the offline phase of the authentication process. Step 502 comprises sending the authentication information to the user for input to the control circuitry 102 and/or 302 as the user-input authentication information. Unless stated otherwise, the aerosol-generating device 100 as well as the control circuitry 102 and/or 302 comprise the same features, elements and/or functions as described elsewhere herein. The method illustrated in FIG. 5 can comprise numerous alternative or additional steps, as described elsewhere herein.

FIG. 6 is a flowchart illustrating a method of device activation including steps from preparation in the factory to user activation. Step 601 comprises, at the factory, storing the pin code in encrypted firmware of the aerosol-generating device 100. The user then obtains the device 100 and activates it for use using one of the flows beginning with steps 602, 607, and 609, respectively. In the case that the user is already registered, the method proceeds to step 602, at which hard age verification is performed, if this has not already been done. Step 603 comprises registering the device 100 to the user, if this has not already been done. Step 604 comprises the user entering or scanning an identity code (“codentify”) on the website to generate the pin code described elsewhere herein. Step 605 comprises the user entering the pin code into the device 100 using the pushbutton 104, in the manner described above. In the case that the user is not already registered, the method proceeds instead from step 601 to step 607, at which hard age verification is again performed on the website, with this being only valid for one device and for one session, with the user being a guest user. Step 608 comprises the user entering or scanning the identity code on the website to generate the pin code, as was done in step 604. The method again then proceeds to step 605. In the case that the user is not able to access the website, the user may call the call centre, in which case the method proceeds from step 601 to step 609, in which the user is authenticated as a registered user or guest. For a guest user, the method proceeds to step 610, at which hard age verification is performed. Step 611 comprises the user entering the identity code on a call centre tool to generate the pin code before the method proceeds to step 605. For a registered user, the method proceeds from step 609 to step 612 at which hard age verification is performed, if this has not already been done. Step 613 comprises registering the device 100 to the user, if this is not already been done. The method then proceeds to step 611. Following step 605, a decision is made at 614 as to whether the entered pin code is correct. If so, the method proceeds to step 606, at which the device 100 is unlocked for use following successful authentication, as described above. If the entered pin code is incorrect, the method proceeds to step 615, at which a count of failed attempts is incremented by 1, before proceeding to step 616, at which a decision is made as to whether the count of failed attempts exceeds a predetermined threshold. If the threshold has not been exceeded, the method returns to step 605. Otherwise, the method proceeds to the online phase at step 617. Although not shown, the method may further comprise a time delay step as described herein between steps 616 and 605. In FIG. 6, generating the pin code corresponds to step 501 of FIG. 5, while the user obtains the pin code via the website or call centre in steps corresponding to step 502. Hard age verification may also be referred to herein as an age verification process. Significantly, entry of the pin code in step 605 does not require any connectivity between the aerosol-generating device 100 (or companion device 300) and any external computing device (such as that described above) nor the use of any app for this purpose.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

It has to be noted that embodiments of the invention are described with reference to different categories. In particular, some examples are described with reference to methods whereas others are described with reference to apparatus. However, a person skilled in the art will gather from the description that, unless otherwise notified, in addition to any combination of features belonging to one category, also any combination between features relating to different category is considered to be disclosed by this application. However, all features can be combined to provide synergetic effects that are more than the simple summation of the features.

While the invention has been illustrated and described in detail in the drawings and foregoing description, such illustration and description are to be considered exemplary and not restrictive. The invention is not limited to the disclosed embodiments. Other variations to the disclosed embodiments can be understood and effected by those skilled in the art, from a study of the drawings, the disclosure, and the appended claims.

The mere fact that certain measures are recited in mutually different dependent claims does not indicate that a combination of these measures cannot be used advantageously.

Any reference signs in the claims should not be construed as limiting the scope.

1.-15. (canceled)

16. An aerosol-generating system, comprising:
control circuitry;
an aerosol-generating device and/or a companion device for the aerosol-generating device, wherein the aerosol-generating device and/or the companion device comprises at least one communications interface configured to provide device connectivity; and
one or more user interface components comprising: i) user interface components of the aerosol-generating device, ii) user interface components of the companion device, or iii) any combination of input and output elements of the aerosol-generating device and of the companion device,
the aerosol-generating device having a locked state in which the aerosol-generating device is prohibited from delivering aerosol and an unlocked state in which the aerosol-generating device is permitted to deliver aerosol, and
the control circuitry being configured to
perform an authentication process for authenticating the user,
during an offline phase of the authentication process, permit the user to make a first predetermined number of attempts to input valid authentication information using the one or more user interface components, wherein the one or more user interface components comprise a button, a touchscreen, or a microphone,
in response to receiving valid authentication information from the user before the first predetermined number of attempts has been exceeded, determine to transition the aerosol-generating device from the locked state to the unlocked state, and
in response to determining that the first predetermined number of attempts has been exceeded before the user has input valid authentication information, proceed to an online phase of the authentication process, wherein the online phase comprises a phase of the authentication process which uses the device connectivity for the purposes of performing the authentication process, wherein the authentication process comprises an age verification process for determining whether the user of the aerosol-generating device has reached the minimum age as indicated by an age threshold.

17. The aerosol-generating system according to claim 16, wherein the control circuitry is further configured to:
respond to an unsuccessful attempt by the user to input valid authentication information during the offline phase by determining whether a second predetermined number of attempts has been exceeded, wherein the second predetermined number of attempts is lower than the first predetermined number of attempts, and
if the second predetermined number of attempts has been exceeded, delay the offline phase until a first time delay period has expired.

18. The aerosol-generating system according to claim 17, wherein the control circuitry is further configured to continue the offline phase without delay if the second predetermined number of attempts has not been exceeded.

19. The aerosol-generating system according to claim 17, wherein the control circuitry is further configured to:
respond to an unsuccessful attempt by the user to input valid authentication information during the offline phase by determining whether a third predetermined number of attempts has been exceeded, wherein the third predetermined number of attempts is lower than the first predetermined number of attempts and higher than the second predetermined number of attempts, and
if the third predetermined number of attempts has been exceeded, delay the offline phase until a second time delay period has expired, the control circuitry being further configured to continue the offline phase without delay if the third predetermined number of attempts has not been exceeded.

20. The aerosol-generating system according to claim 19, wherein the second time delay period is longer than the first time delay period.

21. The aerosol-generating system according to claim 17, wherein the control circuitry is further configured to delay the offline phase by prohibiting the user from inputting further authentication information using the one or more user interface components or by refraining from authenticating the user based on further authentication information input by the user.

22. The aerosol-generating system according to claim 16, wherein the control circuitry is further configured to receive, during each attempt of the offline phase, user-input authentication information from the one or more user interface components and to authenticate the user by determining the validity of the user-input authentication information.

23. The aerosol-generating system according to claim 22, wherein the control circuitry is further configured to receive the user-input authentication information during multiple time windows of predetermined duration, each time window corresponding to a respective digit of a sequence of digits forming the authentication information, and to attribute user input received via the one or more user interface components during a time window of the multiple time windows to the digit corresponding to the time window.

24. The aerosol-generating system according to claim 16, wherein the control circuitry is further configured, during the online phase of the authentication process, to:
transmit an unlock request to a server to transition the aerosol-generating device from the locked state to the unlocked state, wherein the unlock request comprises unique device-identification information identifying the aerosol-generating device and time-limited nonce information corresponding to an unlockable feature of the aerosol-generating device, receive an unlock grant from the server in response to the transmitted unlock request, and
transition the aerosol-generating device from the locked state to the unlocked state in response to reception of the unlock grant.

25. The aerosol-generating system according to claim 24, wherein the control circuitry is further configured to transition the aerosol-generating device from the locked state to the unlocked state in response to reception of the unlock grant by: decrypting the unlock grant, determining whether the decrypted unlock grant comprises the unique device identification information and the time-limited nonce information, and unlocking the unlockable feature in response to determination that the decrypted unlock grant comprises the unique device-identification information and the time-limited nonce information.

26. The aerosol-generating system according to claim 16, wherein the control circuitry is further configured to determine the validity of user-input authentication information using a key derivation mechanism.

27. The aerosol-generating system according to claim 16, wherein the control circuitry is further configured, during the online phase of the authentication process, to:
transmit an unlock request to a server to transition the aerosol-generating device from the locked state to the unlocked state,
receive an unlock grant from the server in response to the transmitted unlock request, and
transition the aerosol-generating device from the locked state to the unlocked state in response to reception of the unlock grant.

28. The aerosol-generating system according to claim 27, wherein the unlock request comprises unique device-identification information identifying the aerosol-generating device and/or time-limited nonce information corresponding to an unlockable feature of the aerosol-generating device.

29. The aerosol-generating system according to claim 16, wherein the control circuitry is: i) fully contained within the aerosol-generating device, ii) fully contained within the companion device, or iii) distributed between the aerosol-generating device and the companion device.
